(19) United States
(12) Patent Application Publication
(10) Pub. No.: US 2009/0119250 A1
(43) Pub. Date: May 7, 2009

(54) METHOD AND SYSTEM FOR SEARCHING AND RANKING ENTRIES STORED IN A DIRECTORY

(76) Inventor: Kenneth Todd Reed, Calgary (CA)

Correspondence Address: BENNETT JONES LLP, 3400 ONE FIRST CANADIAN PLACE, PO BOX 130, TORONTO, ON, M5X 1A4, CA

(21) Appl. No.: 11/911,172

(22) PCT Filed: Apr. 13, 2006
(86) PCT No.: PCT/CA06/00593

§ 371 Date: Aug. 28, 2008

Related U.S. Application Data
(60) Provisional application No. 60/670,512, filed on Apr. 13, 2005.

(51) Int. Cl. G06F 17/30; G10L 15/00; G06F 7/00

(52) U.S. Cl. 707/3; 704/270.1; 707/104.1; 704/E15.001; 707/E17.032

(57) ABSTRACT

A method and system for searching and sorting or ranking entries from a directory. In one embodiment, the directory comprises a database of business listings and the directory is accessed by users through a telecommunication or voice network. A user utilizes voice commands or requests to specify a search for a business. The system conducts a search based on the request and ranks the located listings based on parameters provided by or associated with the user and/or the business listings. The parameters include proximity of the business to the location of the user, category of the business listing in the directory, or a weighting factor assigned to the business listing.

### FIELD OF THE INVENTION

The present invention relates to a directory systems, and more particularly to a method for searching and ranking entries in a directory or database.

### BACKGROUND OF THE INVENTION

The printed version of the yellow pages is a well-known source used for finding information about a business. In recent years, online web-based versions of the yellow pages have also become popular. Both the printed and online versions of the yellow pages directory are instances of visual interfaces. An alternate interface to the yellow pages directory is an oral interface or voice interface. There are two known uses of a voice interface to the yellow pages. The first involves providing a voice interface when access to a physical copy of the printed yellow pages directory, or electronic access via a computer terminal connected to the Internet is not possible. The second involves providing a voice interface for a visually impaired user.

It will be appreciated that a voice interface has several limitations, as compared to a visual interface. A voice interface is severely bandwidth limited when compared to a visual interface. For instance, a person is able to visually scan a hundred listings from the yellow pages in less than a minute, but it would take a long time to listen to the same one hundred listings when presented verbally. Using spoken language as a communication channel is comparatively inefficient and has bandwidth limitations.

In the context of a directory application, such as a business directory e.g. the yellow pages, the inherent bandwidth limitation in a voice interface gives rise to a number of implications. First, the normal presentation order of listings (typically by category and then alphabetical) used in the print version of the yellow pages is not practical for a voice interface. Second, the yellow pages provide an advertising channel for businesses. Typically, there is an obligation by the publisher to give listings equitable exposure, in accordance to the advertisers' disbursement to the directory publisher. In the printed yellow pages, display ads of various sizes can be purchased to increase the visibility of a listing. With a voice interface, there is no similar option. Given the bandwidth limitation of a voice interface, one-way of increasing the exposure of a listing is to present the listing more frequently and earlier. Third, the effectiveness and utility of a voice interface to a directory, such as the yellow pages, for both users and businesses, is largely dependent on the presentation order of the listings.

Accordingly, there remains a need for improvements in the art.

### SUMMARY OF THE INVENTION

The present invention provides a method for searching and ranking entries in a database. In one embodiment, each entry has an associated geographic location and other auxilliary information.

According to one embodiment, the ranking is based on the proximity of an entry's location to a defined search locus. Auxiliary information may be used to further rank entries of similar proximity.

In accordance with another embodiment, the invention comprises a method for searching a business directory for a business entry, where the business associated with the entry is near or proximate a particular geographic location.

In a first aspect, the present invention provides a method for searching entries in a directory coupled to a voice interface, the method comprises the steps of: receiving a voice request from a user through the voice interface for searching the directory; retrieving one or more listings associated with the voice request; each of the listings including one or more indicators; ranking the one or more listings, the ranking being based on one or more of the indicators associated with the listings; and presenting the one or more ranked listings over the voice interface to the user.

In another aspect, the present invention provides a method for searching business listings stored in a database, the database is coupled to a speech recognition server and the speech recognition server is connected to a communication network, the method comprises the steps of: receiving a voice request from a user through the communication network, the voice request is converted into a query by the speech recognition server; retrieving one or more listings from the database based on the query; determining a feature indicator for each of the retrieved listings; sorting the retrieved listings; converting the sorted listings into human intelligible voice signals and playing back the human intelligible voice signals to the user.

In yet another aspect, the present invention provides a system for searching business listings stored in a database, the database is coupled to a communication network, the system comprises: a voice node for connecting the database to the communication network, the voice node comprises a speech recognizer and an application server; the speech recognizer includes a component for receiving a voice request from a user from the communication network and converting the voice request into a query; the application server includes a component for retrieving one or more listings from the database based on the query; the application server includes a component for sorting the retrieved listings based on a feature indicator, and at least some of the listings including respective feature indicators; the speech recognizer includes a component for converting one or more of the sorted listings into a voice signal for the user.

In a further aspect, the present invention provides a computer program product comprising: a medium having computer readable code embodied therein for execution by a computer for searching listings in a directory; the computer readable code includes, code means for receiving a voice request from a user, and code means for converting the voice request into a query; code means for retrieving one or more listings from the directory based on the query; code means for determining a feature indicator for each of the retrieved listings; code means for sorting the retrieved listings based on said feature indicator; and code means for converting the sorted listings into voice signals for the user.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form a networked communication system incorporating a directory database search and ranking mechanism according to an embodiment of the present invention;

FIG. 2 shows in flowchart form a method for searching a directory database according to an embodiment of the present invention;

FIG. 3 shows a step function for the searching algorithm according to a first embodiment;

FIG. 4 shows a step function for the searching algorithm according to a second embodiment;

FIG. 5 shows a step function for the searching algorithm according to a third embodiment;

FIG. 6 shows a step function for the searching algorithm according to a fourth embodiment; and

FIG. 7 shows in diagrammatic form an exemplary search for a business listing in accordance with the present invention.

### DETAILED DESCRIPTION OF THE EMBODIMENTS OF THE INVENTION

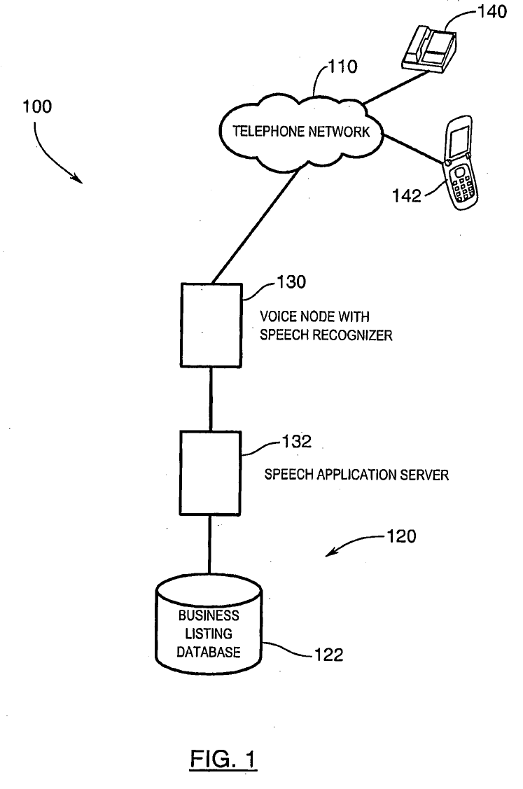

Reference is first made to FIG. 1, which shows in diagrammatic form a communication network incorporating a directory search system and method according to the present invention and indicated generally by reference 100. As shown, the communication network and directory search system 100 comprises a telecommunication network 110 and a directory database 120. The telecommunication network 110 may comprise, for example, a public or a private telephone or voice network or a combination thereof. The directory database 120 in the context of the following description comprises a business listings database 122. The directory database 120 is coupled to the telecommunication network 110 through a voice interface comprising a voice node 130 and a speech application searcher 132. The voice node 130 includes a speech recognition module or application.

Users or subscribers use telecommunication devices, for example, a fixed line telephone set 140, or wireless or cellular communication devices 142, to communicate with each via the telecommunication network 110 by dialing the directory number or DN associated with another user's telephone. The voice node 130 is also assigned a directory number and a user dials the directory number of the voice node 130 to initiate a call session with the directory database 120. The voice node 130 with the automated speech recognition module handles the call, and the speech application server 132 controls the call session. During a call session, the speech application server 132 runs software to execute several dialog forms, which include system prompts or questions to the caller and then listening for the response(s) from the calling user. The speech recognition module in the voice node 130 interprets the response(s) received from the user and includes a voice recognition engine, for example, which converts the voice responses into data or digital information. The software may also include a component or function for determining a physical location for the calling user, for example, based on the location of the user's telephone 140 or the cellular phone 142. As described in more detail below, the position or location of the user is an indicator or parameter, which may be used for sorting or ranking listings. Through such a sequence of dialogs, the system obtains information (e.g. parameters or characteristics) about a business the user is searching, and then executes the searching mechanism, and when necessary, the ranking mechanism according to the present invention.

The searching and ranking mechanisms are implemented as software on the speech application server 132 and may comprise a standalone computer program (e.g. a computer program product), a component of software in a larger program, or a plurality of separate programs, or software, hardware, firmware or any combination thereof. The particular implementation or programming for the software or code components for performing the functions and/or operations associated with the embodiments of the processes and systems according to the invention will be readily understood by one skilled in the art. While described in the context of a voice-based networked communication system, it will be appreciated that the present invention has wider applicability and is suitable for other types of database or directory searches.

In the present description, certain terms are defined as follows:

merchant: a business, person, association, or other entity whose name is listed in the yellow pages.

consumer: the person seeking information from the yellow pages about a merchant.

listing: a single entry in the yellow pages that contains a merchant's name and possibly additional information about the merchant, such as the merchant's telephone number, address, hours of business, etc.

category: a collection of listings that are somehow topically related. For example, florists is a category that contains merchants that are florists.

score or points: a value, for example, a number associated with a listing. In general, scores are proportional to how much money the merchant has spent for the listing, and should reflect the listing's exposure. Scores are unit-less, and the relevancy of their value only has meaning when compared to the scores of other listings. In the context of the present description, a listing with a higher score is presented more frequently than a listing with a lower score.

search locus: the area of focus for a search. This is typically the geographic area where the consumer wants to obtain services from a merchant.

A business directory contains a large number of listings organized by category. According to one embodiment, a listing in the directory includes: a name for the business, i.e. a business name; a category indicator or identifier; a geographical indicator or location, for example, position represented as longitudinal and latitudinal coordinates; and a score. The score comprises a value, for example, an arbitrary numeric value or a non-negative number, which is proportional to the desired exposure of the listing. In other words, all other things being equal, a listing with a higher score is more likely to be presented than another listing with a lower score. The listing score may, for example, be derived from the advertiser's subscription rate or disbursement to the directory publisher for carrying the listing. Handling of the listing score, denoted for example by lₛ, is described in more detail below.

In the following description, the notation l=(n, c, p, s) is used to represent a listing denoted by “l”, and where: the business name is represented by “n”, the category the entry is listed under is represented by “c”, the geographic location or position is represented by “p”, and the listing score is represented by “s”. Furthermore, the notation lₙ, l_{c}, lₚ, and lₛ is used when referring to a particular attribute of a listing l in the accompanying description.

A query “Q” of the business directory listings is denoted as Q=(c, S), and comprises a category c and a geographic search area S. According to one aspect or embodiment, the geographic search area S comprises a region or region having a radius centered on a locus or point, and where in most cases the locus will correspond to the location or geographic position of the user, e.g. the person performing the search. The location of the user is determined, for example, using coordinates associated with the user's cellular telephone, or other types of positioning technologies.

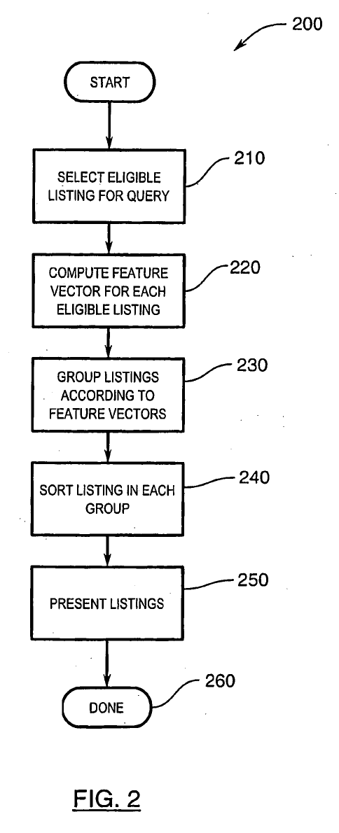

Reference is next made to FIG. 2, which shows in flowchart form a searching and ranking method or algorithm indicated generally by reference 200. As shown, the first step indicated by reference 210 comprises obtaining or retrieving a plurality of listings indicated generally by reference L. The eligible listings may be represented as a set. The eligible listings L comprise listings lₙ having a category which matches a query category denoted by c and a geographic location which falls within a search area denoted by S. The eligible listings L may be represented as follows:

L={l: lₚ ∈S and l_{c}=C}={l₁, . . . , lₙ}

According to an embodiment, the plurality of eligible listings l₁, . . . , lₙ (i.e. unordered set) are ranked. The eligible listings lₙ for a query Q are ranked according to a feature vector represented by F as follows:

F(Q, l)=(f₁, . . . , fₙ)

A feature fₙ is any measurable property or characteristic or parameter that can be derived from the query and/or a listing. The feature vectors have an ordering, and the ordering of the feature vectors is used to rank the listings. In one embodiment, a feature vector F is defined as follows:

F(Q, l)=(f₁, . . . , f₂)=(d, p).

where d is the effective distance between the geographic location lₚ associated with the listing and the geographic search area or locus, i.e. S. The effective distance d is obtained by applying the actual distance to a step function that is parameterized according to the importance of proximity, as described in more detail below. The parameter p is associated with the listing score lₛ, and defined as follows:

p=0 if lₛ>0

p=1 if lₛ=0

It will be appreciated that utilizing a feature vector having this form allows more than one listing to have the same feature vector. This, in turn, provides the capability to cluster similar listings together, and allows for some variability in the ranking of listings. For example, a plurality or set of eligible listings having a feature vector K is represented as follows:

L_{K}={lᵢ: F(Q, lᵢ)=K}

where: K₁, K₂, . . . , Kₙ represent the ordered sequence of distinct feature vectors for all the listings in L, and L′_{Ki} represents the sorted listings from L_{Ki}. According to one embodiment, a probabilistic selection algorithm is used to sort L_{Ki}, for example, as described in more detail below. The sorted listings are presented in order from the concatenations of L′_{K0}, L′_{K1}, . . . , up to a predetermined maximum number of listings.

Referring back to FIG. 2, the next step in block 220 comprises computing or generating a feature vector function F for each eligible listing. According to one embodiment, the feature vector F comprises:

F(Q, l)=(d, p)

where,

d=s(D(lₚ, S))

p=0 if lₛ>0

p=1 if lₛ=0

D(p, R)=the distance between the point p and the area R

s(d)=a step function that converts or associates distances to effective distances, e.g. integral values

The role of the step function, i.e. s(d), is to transform real distances to effective distances. The effective distances are used to determine the influence of proximity in the final ranking of listings. It will be appreciated that the importance of proximity can vary, and typically, depends on the nature of or characteristics associated with the query category c. For example, consider the query categories of coffee houses and car dealerships. For the coffee houses query category, proximity or distance is important, for example, because a person does not wish to travel a long distance to obtain a cup of coffee. On the other hand, when searching for a car dealership, proximity is still relevant, but not to the same extent as would be in a search of coffee houses. For other types of query categories, proximity or distance may not be relevant, and another suitable step function may be selected or modified.

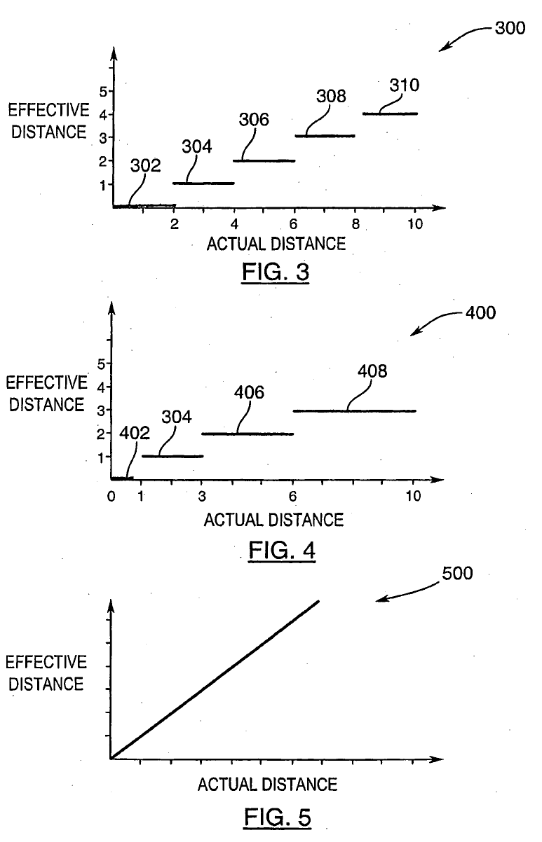

Reference is made to FIG. 3, which shows a uniform step function according to one embodiment and indicated generally by reference 300. The uniform step function 300 as shown comprises uniform steps, for example, a 0-to-2 step indicated by reference 302, a 2-to-4 step indicated by reference 304, a 4-to-6 step indicated by reference 306, a 6-to-8 step indicated by reference 308, and an 8-to-10 step indicated by reference 310. By way of example, consider a query wherein one listing l₁ has an actual distance of 2.3 to the search locus, and another listing l₂ has an actual distance of 3.9 to the search locus, i.e. the distance from the geographic location of the listing to the search locus. It will be appreciated that the actual units of measurement are not needed. Applying the uniform step function 300 in FIG. 3, to the actual distance of 2.3 for the first listing l₁ gives an effective distance of 1, and similarly, the actual distance of 3.9 gives an effective distance of 1. For the step function 300 of FIG. 3, any actual distance in the range 2.0 to 4.0 gives an effective distance of 1 based on the 2-to-4 step 304. For a listing l₃ having an actual distance of 6.7, the uniform step function 300 provides an effective distance of 3 (i.e. the 6-to-8 step 308), and the listing l₃ would be regarded as being farther than the locations for listings l₁ and l₂. The step function may take other forms, for example, as described below.

As indicated above the feature vector F(Q, l) according to one embodiment incorporates a listing score lₛ, and wherein:

p=0 if lₛ>0

p=1 if lₛ=0

It will be appreciated that by defining p this way, for the same proximity, listings with a non-zero listing score lₛ are presented before listings with the listing score lₛ=0. According to one embodiment, a listing score lₛ=0 corresponds to a listing for a non-paying advertiser. Therefore, this definition of p gives preference to paying advertisers over non-paying advertisers listed in the directory.

Referring back to FIG. 2, the next operation in step 240 involves sorting or ranking each set of listings L_{Ki}. According to one embodiment, a probabilistic selection algorithm is utilized for the sorting. The effect of using probabilistic selection is that, for multiple executions of the algorithm with the same query Q, the order of the presented listings varies, and the algorithm will behave nondeterministically. It will be appreciated that this is a desirable effect in a limited bandwidth interface, like a voice interface, because not all eligible listings will be presented for a single query. Due to the limited bandwidth of the voice interface, only a small number of listings, for example N listings, will be presented before the user grows impatient. If the same N listings are presented for every execution of the query Q, then many listings may never be presented at all, and it becomes a little value proposition for the advertiser to be listed in the directory. After the playback or presentation in step 250, the process 200 terminates, e.g. returns, to the calling program or function, as indicated by step 260.

In accordance with this aspect, the probabilistic selection algorithm comprises assigning a probability pᵢ to each listing in L_{Ki}=l₁, . . . , lₙ, such that Σi ᵢpᵢ=1 (i.e. sum(pᵢ, . . . , pₙ)=1), and where pᵢ represents the probability of lᵢ being selected. The algorithm iteratively selects one listing at a time, adjusting the probabilities of the remaining listings after each iteration and until all listings have been selected. By way of another example, let S=s₁, . . . sₙ, be the set of items to be sorted. Let wᵢ>=0 be a weight associated with sᵢ. In this example, wᵢ are integers and represent the number of raffle tickets belonging to sᵢ. The probabilistic sorting algorithm operates by repeatedly selecting a raffle ticket from the set of raffle tickets. Each selection of a raffle ticket removes an element sₖ from the set S, and also removes all the raffle tickets associated with sₖ from the next draw. The process is repeated until all the elements have been selected from the set S. The resulting outcome is an ordered list with items with higher weights more likely to appear before items with lower weights as will be understood by one skilled in the art.

The next operation in step 250 comprises presenting the listings to the user. For an implementation having a voice interface, which includes, for example, a data (text) to speech engine or component that converts the sorted or ranked listings (or selected ones of the sorted listings) into voice signals for playback to the user, for example, as a voice message, announcement or other type of vocalized information, and the user may be provided with playback options.

In one embodiment of the algorithm, the probabilities pi are proportional to the listing scores lₛ. Therefore, listings with higher scores are more likely to be selected and may be presented earlier and/or more often than listings with lower scores.

For the uniform step function 300 described above with reference to FIGS. 2 and 3, the size of each step in the step function is generally inversely proportional to the importance of proximity. In other words, the smaller the steps, the greater relevance proximity will have in the ranking. Alternatively, the longer each step, the less influence proximity will have in the ranking. An example, of such a step function is depicted in FIG. 4 and indicated generally by reference 400. The step function 400 comprises four non-uniform steps: a 0-to-1 step indicated by reference 402, a 1-to-3 step indicated by reference 404, a 3-to-6 step indicated by reference 406, and a 6-to-10 step indicated by reference 408. The corresponding effective distances are 0, 1, 2 and 3, respectively, as indicated in FIG. 4.

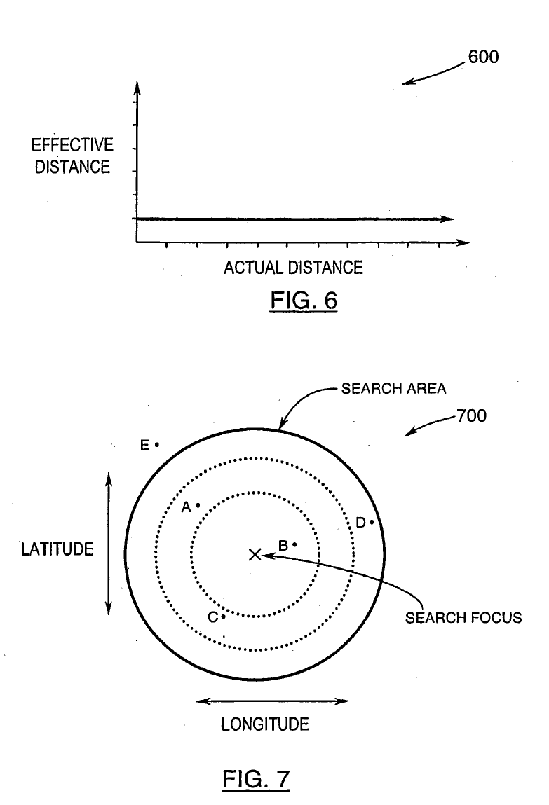

Reference is next made to FIGS. 5 and 6, which show other embodiments of step functions. FIG. 5 shows an identity function indicated generally by reference 500, which can be viewed as a step function where each step has zero length, i.e. a form of degenerative step function. It will be appreciated that with the identity function 500, proximity is relevant, to the exclusion of other attributes. FIG. 6 shows another form a degenerative step function comprising a horizontal line and being indicated generally by reference 600. The function 600 of FIG. 6 may be considered a step function where the first step has infinite length. According to the function 600, the listings are treated as being the same distance to the search locus, and as such proximity is not important, for example, in the ranking of the listings.

Reference is next made to FIG. 7, which further illustrates an embodiment of the present invention in the context of an exemplary query category for “Coffee Houses”. The Coffee Houses category comprises five coffee houses, each denoted by A, B, C, D and E, respectively. Each of the listings, i.e. coffee houses, located in the query has a respective “Score” (e.g. listing score lₛ) as indicated below.

| Name | Category | Score |
|---|---|---|
| A | Coffee Houses | 10 |
| B | Coffee Houses | 0 |
| C | Coffee Houses | 5 |
| D | Coffee Houses | 10 |
| E | Coffee Houses | 10 |

After applying the first step 210 according to the process 200 described above with reference to FIG. 2, the eligible listings (e.g. set) L comprises Coffee Houses A, B, C and D. The listing for Coffee House E is omitted or dropped because its location is outside of the search area S.

The next step 220 as described above with reference to FIG. 2 comprises computing a feature vector F(Q, l) for each of the eligible listings, i.e. the Coffee Houses A, B, C and D. The following table shows exemplary calculated values for the feature vector F(Q, l) for each of the Coffee House listings L:

| Name | Category | Score | F(Q, I) |
|---|---|---|---|
| A | Coffee Houses | 10 | (1, 0) |
| B | Coffee Houses | 5 | (0, 1) |
| C | Coffee Houses | 5 | (1, 0) |
| D | Coffee Houses | 10 | (2, 0) |

In this example, there are three distinct values for the feature vector F(Q, l), namely K₁=(0, 1), K₂=(1, 0), and K₃=(2, 0). Accordingly, L_{K1}={B}, L_{K2}={A C}, and L_{K3}={D} (for example, as described above for step 230 in the process 200 of FIG. 2). Only L_{K2} has more than one item, and these items are sorted using a probabilistic selection method as described above. In accordance with the embodiment, the probability of Coffee House A being selected is 0.6666 and the probability of C being selected is 0.3333, and notwithstanding the probabilities, either L′_{K2}=[A, C] or L′_{K2}=[C, A]. Therefore, for this example, the outcome of the ranking is either [B, A, C, D] or [B, C, A, D].

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method for searching entries in a directory coupled to a voice interface, said method comprising the steps of:
receiving a voice request from a user through said voice interface for searching the directory;
retrieving one or more listings associated with said voice request;
each of said listings including one or more indicators;
ranking said one or more listings, said ranking being based on one or more of the indicators associated with the listings; and
presenting said one or more ranked listings to the user over said voice interface.

2. The method as claimed in claim 1, further including the step of providing a location associated with the user making said voice request.

3. The method as claimed in claim 2, wherein said one or more listings includes a physical location for an entity associated with said listing and said step of ranking comprises ranking said one or more listings based on proximity of the location of said user to the physical location of said associated entity.

4. The method as claimed in claimed 3, wherein said indicators include a listing score, wherein said ranking is based on said listing scores when two or more of said listings have similar proximities.

5. A method for searching business listings stored in a database, said database being coupled to a speech recognition server and said speech recognition server being connected to a communication network, said method comprising the steps of:
receiving a voice request from a user through the communication network, said voice request being converted into a query by said speech recognition server;
retrieving one or more listings from the database based on said query;
determining a feature indicator for each of said retrieved listings;
sorting said retrieved listings based on said feature indicator;
converting said sorted listings into voice signals for said user.

6. The method as claimed in claim 5, further including the step of grouping said retrieved listings according to said feature indicators, and wherein said step of sorting comprises sorting the listings in each of said groups.

7. The method as claimed in claim 5, wherein said feature indicators comprise one or more feature vectors, and each of said feature vectors including one or more parameters related to said listing.

8. The method as claimed in claim 7, further including the step of grouping said retrieved listings according to said feature vectors, and wherein each of said feature vectors comprises one or more features associated with said respective listing.

9. The method as claimed in claim 8, wherein said step of sorting comprises ordering said feature vectors, and wherein said features associated with said respective listings includes a score, and said step of sorting being responsive to said score for ordering two or more of said listings wherein said listings have the same or similar feature vectors.

10. The method as claimed in claim 8, further including the step of determining a proximity for one or more of said listings, said proximity being based on a location of an entity associated with said listing and a physical location associated with said user.

11. The method as claimed in claim 10, wherein said step of sorting comprises ordering said feature vectors, and wherein said features associated with said respective listings includes a score, and said step of sorting being responsive to said score for ordering two or more of said listings wherein the proximity for two or more of said listings falls within a predetermined range.

12. A system for searching business listings stored in a directory, said directory being coupled to a communication network, said system comprising:
a voice node for coupling said directory to said communication network, said voice node comprising a speech recognizer and an application server;
said speech recognizer including a component for receiving a voice request from a user from said communication network and converting said voice request into a query;
said application server including a component for retrieving one or more listings from the directory based on said query;
said application server including a component for sorting said retrieved listings based on a feature indicator, and at least some of said listings including respective feature indicators;
said speech recognizer including a component for converting one or more of said sorted listings into a voice signal for said user.

13. The system as claimed in claim 12, wherein said feature indicator comprises a feature vector, and each of said feature vectors including one or more parameters related to said associated listing.

14. The system as claimed in claim 13, wherein said application server includes a component for grouping said retrieved listings according to said feature vectors.

15. The system as claimed in claim 14, wherein said feature vectors include a score for said associated listing, and said component for sorting being responsive to said score for ordering two or more of said listings when said listings have similar feature vectors.

16. The system as claimed in claim 14, further including a component for determining a proximity, said proximity being based on a relative distance between a location associated with said user and a location for an entity associated with said listing.

17. The system as claimed in claim 16, further including a component for converting said proximity into an effective distance, and said component for sorting being responsive to said effective distance for ranking two or more of said listings.

18. The system as claimed in claim 17, wherein said feature vectors include a score for said associated listing, said component for sorting being responsive to said score for ranking two or more of said listings when said respective listings have effective distances within a predefined range.

19. The system as claimed in claim 18, wherein said score is based on an expenditure by the entity for placing a listing in said directory.

20. A computer program product, comprising:
a medium having computer readable code embodied therein for execution by a computer for searching listings in a directory;
said computer readable code including,
code means for receiving a voice request from a user, and code means for converting said voice request into a query;
code means for retrieving one or more listings from the directory based on said query;
code means for determining a feature indicator for each of said retrieved listings;
code means for sorting said retrieved listings based on said feature indicator;
code means for converting said sorted listings into voice signals for said user.

21. The computer program product as claimed in claim 20, further including code means for grouping said retrieved listings according to said feature indicators, and wherein said means for sorting sorts the listings in each of said groups.
